(19) United States
(12) Patent Application Publication
(10) Pub. No.: US 2026/0310807 A1
(43) Pub. Date: Oct. 8, 2026

(54) METHODS AND SYSTEMS FOR SECURE AND COMPLIANT OPEN BANKING DATA SHARING

(71) Applicant: Mastercard International Incorporated, Purchase, NY (US)

(72) Inventors: Kaushal Shetty, O'Fallon, MO (US); Devanshu Bhardwaj, Hisar (IN); Giovane Barnes, O’Fallon, MO (US); Hitesh Panwar, Singhana (IN); Mishwa Bhavsar, Dardenne Prairie, MO (US)

(73) Assignee: Mastercard International Incorporated, Purchase, NY (US)

(21) Appl. No.: 19/098,736

(22) Filed: Apr. 2, 2025

(51) Int. Cl. G06F 21/62

(52) U.S. Cl. CPC G06F 21/6218

(57) ABSTRACT

Techniques for secure and compliant data sharing in the context of open banking are disclosed. The techniques include a centralized data repository storing customer financial data, an API gateway, a localization engine, and a machine learning module. A system authenticates and authorizes data access requests based on requester credentials and customer consent. Geographical locations of the requester and a data repository are mapped to regulatory categories using localization guidelines. A localization engine evaluates permissible country combinations for data processing and storage, identifies alternative data-sharing paths, and assigns prioritization scores incorporating regulatory compliance, infrastructure cost, and latency. The system selects the optimal data-sharing path with the lowest score, retrieves the requested data from the repository, applies required transformations, and securely transmits the data to the requester.

### BACKGROUND OF THE DISCLOSURE

The field of the disclosure relates generally to secure and compliant data sharing in the context of open banking, and, more particularly, to the use of artificial intelligence and machine learning to dynamically adapt data-sharing policies and optimize workflows based on geographical, regulatory, and operational requirements.

The rapid growth of open banking has created a demand for secure and efficient systems that facilitate data sharing between financial institutions and third-party service providers. Open banking initiatives require financial data to be shared in compliance with complex and ever-evolving regulations that vary by country and region. These regulations often include stringent data localization requirements, such as restricting cross-border data transfers or mandating local processing and storage of sensitive data. Additionally, cultural norms and privacy expectations further complicate the data-sharing process, necessitating tailored approaches for different geographical contexts. Existing systems often lack the flexibility and intelligence to adapt dynamically to these requirements, leading to inefficiencies, compliance risks, and inconsistent customer experiences.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a method is provided. The method includes receiving, via an application programming interface (API) gateway, a data access request from a data requester. The data access request includes one or more parameters identifying the data requester, a geographical location of the data requester, requested data, and a type of data requested. The method also includes authenticating and authorizing the data access request based on credentials of the data requester and customer consent permissions. Furthermore, the method includes identifying the geographical location of the data requester and a geographical location of a centralized data repository storing the requested data to determine one or more applicable regulatory requirements. Additionally, the method includes mapping each identified geographical location to a country category based on localization guidelines. The method also includes identifying one or more permissible country combinations for data processing and data storage locations based on the country categories, wherein each combination defines a data-sharing path. Furthermore, the method includes analyzing one or more alternative data-sharing paths. In addition, the method includes determining a prioritization score for each data-sharing path and alternative data-sharing path using a scoring mechanism that incorporates infrastructure cost, data processing latency, and regulatory compliance factors. The method includes selecting a data-sharing path having the lowest prioritization score, retrieving the requested data from the centralized data repository, and securely transmitting the requested data to the data requester through the API gateway along the selected data-sharing path.

In another aspect, a system is provided. The system includes a centralized data repository storing customer financial data thereon, and a data sharing system. The data sharing system includes an application programming interface (API) gateway, a localization engine, a machine learning module, one or more processors, and a memory. The memory stores executable instructions that, when executed by the one or more processors, cause the one or more processors to receive, via the API gateway, a data access request from a data requester. The data access request includes one or more parameters identifying the data requester, a geographical location of the data requester, the customer financial data being requested, and a type of data requested. The one or more processors authenticate and authorize, via the API gateway, the data access request based on credentials of the data requester and customer consent permissions. Furthermore, the one or more processors identify, via the localization engine, the geographical location of the data requester and a geographical location of a centralized data repository storing the requested data to determine one or more applicable regulatory requirements. The one or more processors map, via the localization engine, each identified geographical location to a country category based on localization guidelines. In addition, the one or more processors identify, via the localization engine, one or more permissible country combinations for data processing and data storage locations based on the country categories, wherein each country combination defines a data-sharing path. Furthermore, the one or more processors analyze, via the localization engine, one or more alternative data-sharing paths. Additionally, the one or more processors determine, via the localization engine, a prioritization score for each data-sharing path and alternative data-sharing path using a scoring mechanism that incorporates infrastructure cost, data processing latency, and regulatory compliance factors. The one or more processors also select, via the localization engine, a data-sharing path having the lowest prioritization score; retrieve the requested data from the centralized data repository; and securely transmit, via the API gateway, the requested data to the data requester along the selected data-sharing path.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and different aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with an embodiment thereof. Further, wherever possible, the following description refers to the reference numerals included in the following figures, in which features depicted in multiple figures are designated with consistent reference numerals.

FIG. 1 is a block diagram of an example multi-party financial data network, in accordance with an embodiment of the present disclosure;

FIG. 2 is an example configuration of a computing device for use in the system shown in FIG. 1;

FIG. 3 is an example configuration of the centralized data repository system for use in the system shown in FIG. 1;

FIG. 4 is a schematic diagram of a data sharing process for use in the system shown in FIG. 1;

FIG. 5 is a schematic diagram of a process flow performed by the localization engine of the data sharing process of FIG. 4;

FIG. 6 is a schematic diagram of a process flow for training the machine learning module of FIG. 1; and

FIG. 7 is a schematic diagram of a model inference process flow for the machine learning module of FIG. 6.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

Broadly, the disclosure provides techniques for facilitating secure, compliant, and efficient data sharing between financial institutions and third-party service providers in the context of open banking. The disclosed techniques address challenges posed by diverse and evolving data localization regulations, privacy laws, and cultural norms, ensuring that financial data is shared in a manner that is both operationally efficient and fully compliant with applicable regulatory requirements. The disclosure provides a system that includes a combination of an API gateway, a centralized data repository, an AI-powered localization engine, and a machine learning module that work together to dynamically optimize data-sharing workflows.

When a data access request is received, the system authenticates and authorizes the data requester based on credentials and customer consent. The localization engine identifies the geographical locations of the data requester and the data repository storing the requested data, maps these locations to predefined regulatory categories, and evaluates permissible combinations for data processing and storage. Using a scoring mechanism that considers regulatory compliance, infrastructure costs, and latency, the localization engine determines an optimal data-sharing path. The machine learning module further enhances the system by analyzing historical data-sharing patterns, customer preferences, and regulatory updates to refine the scoring and path selection process.

By leveraging advanced AI and machine learning technology, the techniques disclosed herein ensure that data-sharing requests are processed securely and efficiently while adhering to regional regulatory frameworks. The techniques also incorporate a continuous improvement mechanism, enabling real-time updates to the localization engine's knowledge base and model optimization through feedback and training. The disclosed techniques provide financial institutions and service providers with a scalable, adaptive, and compliant solution for sharing sensitive customer data in a globalized open banking ecosystem.

### Exemplary System

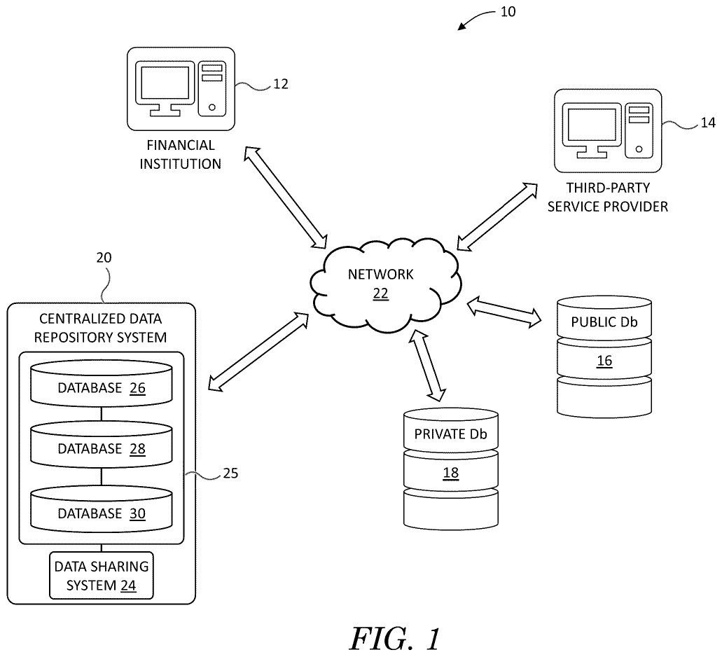

FIG. 1 is a block diagram of an example multi-party financial data network 10, in accordance with an aspect of the present disclosure. The data network 10 provides secure, compliant, and efficient data sharing between financial institutions and third-party service providers within the framework of open banking. The data network 10 addresses the complexities of complying with data localization laws and regional privacy regulations while optimizing the data sharing workflow to minimize latency and infrastructure costs. In addition, the data network 10 enables data sharing in which the financial institutions, third-party service providers, and data provider do not need to have a one-to-one relationship. Although parts of the data network 10 are presented in one arrangement, other embodiments may include the same or different parts arranged otherwise, depending, for example, on authorization processes for purchase transactions, communication between computing devices, etc.

In the example embodiment, the data network 10 generally includes a financial institution(s) 12, a third-party service provider(s) 14, a public database(s) 16, a private database(s) 18, and a centralized data repository system 20, coupled in electronic communication via a network 22. The centralized data repository system 20 includes a data sharing system 24 and a centralized data repository (CDR) 25. The data sharing system 24 is coupled to the CDR 25. The CDR 25 includes a plurality of databases, such as databases 26, 28, and 30.

Each of the financial institution(s) 12, the third-party service provider(s) 14, the public database(s) 16, and the private database(s) 18 may include a desktop computer, a laptop or tablet computer, an application server, a database server, a file server, or the like, or combinations thereof, configured to periodically or continuously provide data and/or data updates to the centralized data repository system 20 to store, for example, in one or more databases, such as the databases 26, 28, and 30 of the CDR 25. The centralized data repository system 20 may include and/or work in conjunction with application servers, database servers, file servers, gaming servers, mail servers, print servers, or the like, or combinations thereof. Furthermore, the centralized data repository system 20 may include a plurality of servers, virtual servers, or combinations thereof.

The network 22 provides wired and/or wireless communication between the financial institution(s) 12, the third-party service provider(s) 14, the public database(s) 16, the private database(s) 18, and the centralized data repository system 20. Each of the financial institution(s) 12, the third-party service provider(s) 14, the public database(s) 16, the private database(s) 18, and the centralized data repository system 20 may be configured to send data to and/or receive data from the network 22 using one or more suitable communication protocols, which may be the same communication protocols or different communication protocols as one another.

The network 22 may include one or more telecommunication networks, nodes, and/or links used to facilitate data exchanges between one or more devices. The network 22 may facilitate a connection to the Internet for devices configured to communicate with network 22. The network 22 may include local area networks, metro area networks, wide area networks, cloud networks, the Internet, cellular networks, plain old telephone service (POTS) networks, and the like, or combinations thereof. The network 22 may be wired, wireless, or combinations thereof and may include components such as modems, gateways, switches, routers, hubs, access points, repeaters, towers, and the like.

The financial institution(s) 12, the third-party service provider(s) 14, the public database(s) 16, the private database(s) 18, and the centralized data repository system 20 may connect to the network 22 either through wires, such as electrical cables or fiber optic cables, or wirelessly. Wireless connection types may include, for example: radio frequency (RF) communication using wireless standards such as cellular 3G, 4G, 5G, and the like; Institute of Electrical and Electronics Engineers (IEEE) 802.11 standards such as Wi-Fi; IEEE 802.16 standards such as WiMAX; IEEE 802.15.1 such as Bluetooth™; or combinations thereof. In aspects in which the network 22 facilitates a connection to the Internet, data communications may take place over the network 22 via one or more suitable Internet communication protocols, which may be the same communication protocols or different communication protocols as one another (e.g., Hypertext Transfer Protocol (HTTP), File Transfer Protocol (FTP), Domain Name System (DNS), Internet Protocol (IP), Simple Network Management Protocol (SNMP), Transmission Control Protocol (TCP), and User Datagram Protocol (UDP)). The term “Internet Protocol” includes Internet Protocol version 4 (IPv4), Internet Protocol version 6 (IPv6), a future-developed internet protocol, or combinations thereof. The network 22 may be implemented as a wireless telephony network (e.g., GSM, CDMA, LTE, etc.), a Wi-Fi network (e.g., via one or more IEEE 802.11 Standards), a WiMAX network, a Bluetooth™ network, etc.

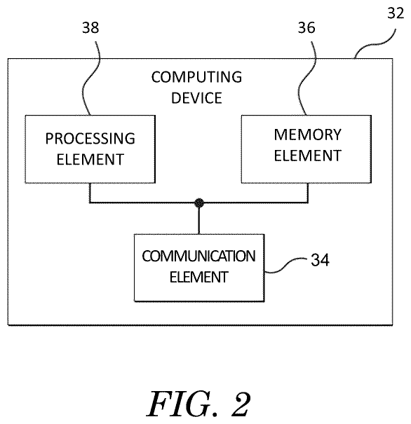

FIG. 2 is an example configuration of a computing device 32. In some embodiments, the computing device 32 is the financial institution 12, the third-party service provider 14, the public database 16, and/or the private database 18 (shown in FIG. 1). In the example embodiment, the computing device 32 may broadly include a communication element 34, a memory element 36, and a processing element 38.

The communication element 34 may generally allow communication with external systems or devices, including the network 22, via wireless communication and/or data transmission over one or more direct or indirect radio links between devices. The communication element 34 may include signal or data transmitting and receiving circuits, such as antennas, amplifiers, filters, mixers, oscillators, digital signal processors (DSPs), and the like. The communication element 34 may establish communication wirelessly by utilizing RF signals and/or data that comply with communication standards such as cellular 3G, 4G, or 5G, Wi-Fi, WiMAX, Bluetooth™, and the like, or combinations thereof. In addition, the communication element 34 may utilize communication standards such as ANT, ANT+, Bluetooth™ low energy (BLE), the industrial, scientific, and medical (ISM) band at 2.4 gigahertz (GHz), or the like.

Alternatively, or in addition, the communication element 34 may establish communication through physical connectors or couplers that receive metal conductor wires or cables that are compatible with networking technologies, such as ethernet. In certain embodiments, the communication element 34 may also couple with optical fiber cables. The communication element 34 may be in communication with corresponding ones of the processing element 38 and the memory element 36 via, for example, wired or wireless communication.

The memory element 36 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 36 may be embedded in, or packaged in the same package as, the processing element 38. The memory element 36 may include, or may constitute, a “computer-readable medium.” The memory element 36 may store computer-executable instructions, code, code segments, software, firmware, programs, applications, apps, modules, agents, services, daemons, or the like that are executed by the processing element 38. The memory element 36 may also store settings, data, documents, sound files, photographs, movies, images, databases, and the like, including the items described throughout this disclosure.

The processing element 38 may include an electronic hardware component such as one or more processors. The processing element 38 may include digital processing unit(s). The processing element 38 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 38 may generally execute, process, or run computer-executable instructions, code, code segments, software, firmware, programs, applications, apps, modules, agents, processes, services, daemons, or the like. The processing element 38 may also include hardware components such as finite-state machines, sequential and combinational logic, and other electronic circuits that can perform the functions necessary for the operation of the current disclosure. The processing element 38 may be in communication with the other electronic components through serial or parallel links that include address busses, data busses, control lines, and the like. Through hardware, software, firmware, or combinations thereof, the processing element 38 may be configured or programmed to perform the functions described herein below.

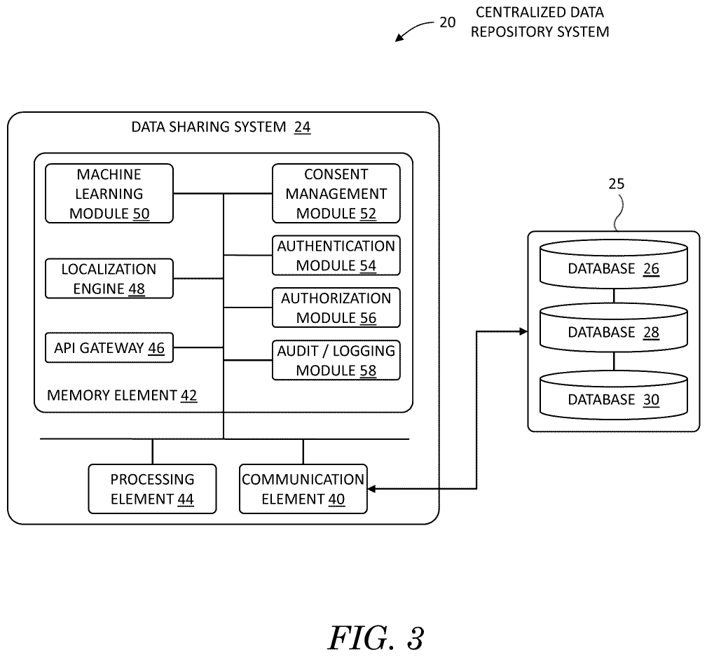

FIG. 3 is an example configuration of the centralized data repository system 20. As discussed above, the centralized data repository system 20 may broadly include the data sharing system 24 and the CDR 25. In the example embodiment, the data sharing system 24 may broadly include a communication element 40, a memory element 42, and a processing element 44.

The communication element 40 may generally allow communication with external systems or devices, including the network 22, via wireless communication and/or data transmission over one or more direct or indirect radio links between devices. The communication element 40 may include signal or data transmitting and receiving circuits, such as antennas, amplifiers, filters, mixers, oscillators, digital signal processors (DSPs), and the like. The communication element 40 may establish communication wirelessly by utilizing RF signals and/or data that comply with communication standards such as cellular 3G, 4G, or 5G, Wi-Fi, WiMAX, Bluetooth™, and the like, or combinations thereof. In addition, the communication element 40 may utilize communication standards such as ANT, ANT+, Bluetooth™ low energy (BLE), the industrial, scientific, and medical (ISM) band at 2.4 gigahertz (GHz), or the like.

Alternatively, or in addition, the communication element 40 may establish communication through physical connectors or couplers that receive metal conductor wires or cables that are compatible with networking technologies, such as ethernet. In certain embodiments, the communication element 40 may also couple with optical fiber cables. The communication element 40 may be in communication with corresponding ones of the processing element 44 and the memory element 42 via, for example, wired or wireless communication.

The memory element 42 may include electronic hardware data storage components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element 42 may be embedded in, or packaged in the same package as, the processing element 44. The memory element 42 may include, or may constitute, a “computer-readable medium.” The memory element 42 may store computer-executable instructions, code, code segments, software, firmware, programs, applications, apps, modules, agents, services, daemons, or the like that are executed by the processing element 44, including—in the case of processing element 44 and the memory element 42—one or more AI or ML software/models or the like. The memory element 42 may also store settings, data, documents, sound files, photographs, movies, images, databases, and the like, including the items described throughout this disclosure.

The processing element 44 may include electronic a hardware component such as one or more processors. The processing element 44 may include digital processing unit(s). The processing element 44 may include microprocessors (single-core and multi-core), microcontrollers, digital signal processors (DSPs), field-programmable gate arrays (FPGAs), analog and/or digital application-specific integrated circuits (ASICs), or the like, or combinations thereof. The processing element 44 may generally execute, process, or run computer-executable instructions, code, code segments, software, firmware, programs, applications, apps, modules, agents, processes, services, daemons, or the like, including one or more AI or ML software/models and/or data analysis processes described throughout this disclosure. The processing element 44 may also include hardware components such as finite-state machines, sequential and combinational logic, and other electronic circuits that can perform the functions necessary for the operation of the current disclosure. The processing element 44 may be in communication with the other electronic components through serial or parallel links that include address busses, data busses, control lines, and the like. Through hardware, software, firmware, or combinations thereof, the processing element 44 may be configured or programmed to perform the functions described herein below.

In the example embodiment, the data sharing system 24 broadly includes an application programming interface (API) gateway 46, a localization engine 48, a machine learning module 50, a consent management module 52, an authentication module 54, an authorization module 56, and an audit/logging module 58.

The API gateway 46 may include a software framework that functions as an intermediary between client devices, such as the financial institution 12, the third-party service provider 14, the public database 16 and/or the private database 18 (shown in FIG. 1), and backend services. The API gateway 46 may provide a unified interface for managing, routing, and optimizing API requests. The API gateway 46 may handle key functions such as authentication, authorization, rate limiting, request transformation, load balancing, and protocol translation.

The authentication module 54 may facilitate validation of the identity of a client (such as the financial institution 12, the third-party service provider 14, the public database 16, and/or the private database 18) accessing the data sharing system 24, for example, via the API gateway 46. For example, in an embodiment, the authentication module 54 may verify a client's identity by checking credentials such as API keys, tokens, or certificates included in an API request. In some embodiments, the authentication module 54 may communicate with an external authentication service or identity provider (not shown) to verify and/or issue secure tokens.

The authorization module 56 may facilitate enforcing one or more policies to determine whether the authenticated client is allowed to access certain data available via the data sharing system 24. For example, the authorization module 56 may evaluate the client's roles and permissions against predefined rules to allow or deny access and/or use attributes such as user location, time, or device type to make authorization decisions. In some embodiments, the authorization module 56 may communicate with an external system or service (not shown) to validate the client's permissions.

The consent management module 52 may facilitate ensuring that data is shared only with authorized clients and within the scope of the granted permissions. For example, the consent management module 52 may validate data owner permissions granted to the client to confirm the scope and specific authorizations for data sharing. The consent management module 52 may enforce the permissions by restricting access or data sharing to actions and clients explicitly authorized by the data owner. In an embodiment, the consent management module 52 may dynamically check permissions in real time, accounting for any updates, revocations, or expirations of consent.

The audit/logging module 58 may facilitate tracking all data access and sharing activities, providing transparency and accountability for regulatory compliance and security purposes. For example, audit/logging module 58 may maintain detailed audit logs of all data access requested by a client, sharing activities performed by the data sharing system, and outputs from the localization engine 48 and/or machine learning module 50 for each data access request/sharing activity. Such audit logs may be used to ensure regulatory compliance and support auditing.

The localization engine 48 may include an artificial intelligence (AI) driven component that dynamically adapts data sharing policies and strategies based on a specific geographical location and regulatory environment. The localization engine 48 may incorporate a knowledge base of local laws, regulations, and cultural norms (available for example from the public and private dB's 16, 18) related to data privacy, retention, and sharing. The localization engine 48 may continuously monitor the public and private dB's 16, 18 for updates and changes in these factors and may adjust data sharing protocols accordingly.

The machine learning module 50 may employ machine learning algorithms to analyze historical data sharing patterns, client preferences, and feedback. The machine learning module 50 may refine and optimize the localization data sharing strategies over time, ensuring compliance, security, and alignment with evolving customer expectations across different regions.

With respect to the CDR 25, it is noted that the databases 26, 28, and 30, described herein, may be database servers and may be discrete servers distributed remotely from one another. In addition, while the CDR 25 is depicted with three (3) databases, it is understood that the CDR 25 may include any number of databases. The CDR 25 may be configured to allow data, such as the transaction data and consumer financial account data, to be stored by a group of computers, and updated by one or more members of the group. While the CDR 25 is illustrated as a single component in FIGS. 1 and 3, it should be appreciated that the CDR 25 may be a network of distributed computers or data centers, each coupled to the centralized data repository system 20, for example, via the network 22. For example, and without limitation, each of databases 26, 28, and 30 may be geographically remote from each other database 26, 28. and 30, and thus data stored on a respective one of the databases 26, 28, and 30, may be subject to respective local laws, regulations, and cultural norms related to data privacy, retention, and sharing.

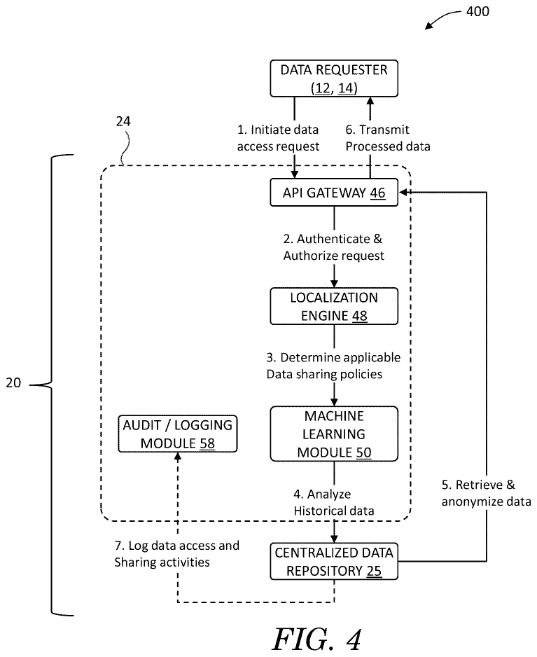

FIG. 4 is a schematic diagram of a data sharing process 400, in accordance with an aspect of the present disclosure. In the example embodiment, initiation of a data access request occurs at step 1. In particular, the data sharing process begins when a data requester, such as a financial institution 12 or third-party service provider 14 (each shown in FIG. 1), initiates a data access request through the API gateway 46. The data access request may include, for example, detailed parameters, such as the data requested, a type of data requested, an intended use case, and any customer-specific details necessary to process the request. The API gateway 46 may serve as the entry point for the centralized data repository system 20, ensuring that requests are standardized and structured for compatibility with the data sharing system 24. The API gateway 46 may also verify that the request complies with the format and protocols required by the centralized data repository system 20, reducing the risk of errors and ensuring seamless integration with the downstream components.

At step 2, the API gateway 46 performs authentication and authorization of the data requester 12, 14. For example, after data access request is received, the API gateway 46 may perform the authentication and authorization checks to ensure the request originates from an authorized source. Authentication may include communicating with the authentication module 54 (shown in FIG. 3) to verify the credentials of the data requester 12, 14 using, for example, industry-standard protocols and secure encryption mechanisms. The authorization process may include communicating with the authorization module 56 (shown in FIG. 3) to ensure that the data requester 12, 14 is permitted to access the specific type of data requested, based on customer consent and one or more predefined access rules. In an embodiment, consent verification may be facilitated through blockchain-based records, regional identity verification systems, or tokenized consent mechanisms. If any inconsistencies or discrepancies are detected, the data sharing system 24 may reject the request and log the rejection reason, for example, via the audit/logging module 58, for further analysis.

At step 3, following successful authentication and authorization, the localization engine 48 dynamically determines applicable data sharing policies for the request. For example, the localization engine 48 may identify the geographical location of the data requester 12, 14 and the requested data in the CDR 25. The localization engine 48 may map these locations to one or more predefined country categories, such as Global (G), Light (L), Medium 1 (M1), Medium 2 (M2), or Strict (S). The country categories are associated with the data processing and data storage requirements shown below in Table 1.

TABLE 1

| Category | Data Processing | Data Storage |
|---|---|---|
| Global (G) | Global | Global |
| Light (L) | Cross border | Cross border |
| | allowed | allowed with |
| | | local copy |
| Medium 1 (M1) | Local only | Cross border |
| | | allowed with |
| | | local copy |
| Medium 2 (M2) | Cross border | Local only |
| | allowed | |
| Strict (S) | Local only | Local only |

The localization engine 48 may evaluate the regulatory requirements for various country pairs and identify permissible combinations for data processing and data storage. If a conflict arises due to differences in data localization laws or privacy regulations, the localization engine 48 may explore one or more alternate configurations to ensure compliance without compromising the efficiency of data sharing.

At step 4, the machine learning module 50 facilitates optimizing the data sharing strategies identified by the localization engine 48. For example, the machine learning module 50 may optimize the outputs of the localization engine 48 by analyzing historical data sharing patterns, data requester preferences, and prior data sharing outcomes. The machine learning module 50 may retrieve historical records to evaluate which strategies have been successful in similar scenarios and may adjust the scoring system used by the localization engine 48 accordingly. For each potential path, the machine learning module 50 may calculate a confidence score based on key metrics, including type of data requester, country category, type of data requested, etc. If the confidence score is below a predefined threshold value because, for example, prior data sharing requests have failed for similar configurations, the machine learning module 50 may alert the data requester and request a final decision on whether or not to process the data access request. If the confidence score is above the predefined threshold value, the data sharing system 24 may automatically transmit the data access request to the CDR 25.

Step 5 includes the retrieval and transformation of the requested data. After determining the optimal data sharing path, the CDR 25 retrieves the requested data, for example, from one or more of the databases 26, 28, and 30. Data transformation or anonymization may be performed as required by the localization engine's strategies. For instance, sensitive data points may be masked, encrypted, or aggregated to comply with regulatory requirements.

At step 6, after the requested data is processed, the data is transmitted securely to the data requester 12, 14 through the API gateway 46. In an embodiment, the data sharing system 24 may employ end-to-end encryption to protect the data in transit, using protocols such as TLS 1.3 to prevent interception or unauthorized access. Additionally, the transmission may be monitored for anomalies, such as unexpected delays or unauthorized attempts to intercept the data. Rate-limiting mechanisms may be applied by the API gateway 46 to ensure that the API gateway 46 remains resilient to potential abuse, such as distributed denial-of-service (DDoS) attacks, while maintaining high performance for legitimate data access requests.

Step 7 includes comprehensive logging and auditing of the data access and sharing activities. For example, the audit/logging module 58 may log details of the data access and sharing activities, such as the times of the request; the identity of the data requester 12, 14; the geographical locations involved in the data access and sharing activities; the selected data sharing path; and the applied strategies/policies. The data logs may be stored securely in an immutable format, ensuring they cannot be tampered with or altered. The audit/logging module 58 may support regular compliance reviews and provide transparency for regulatory bodies. Additionally, the data logs may be analyzed periodically using, for example, automated tools to identify potential areas for improvement in the data sharing process, such as reducing latency or enhancing security.

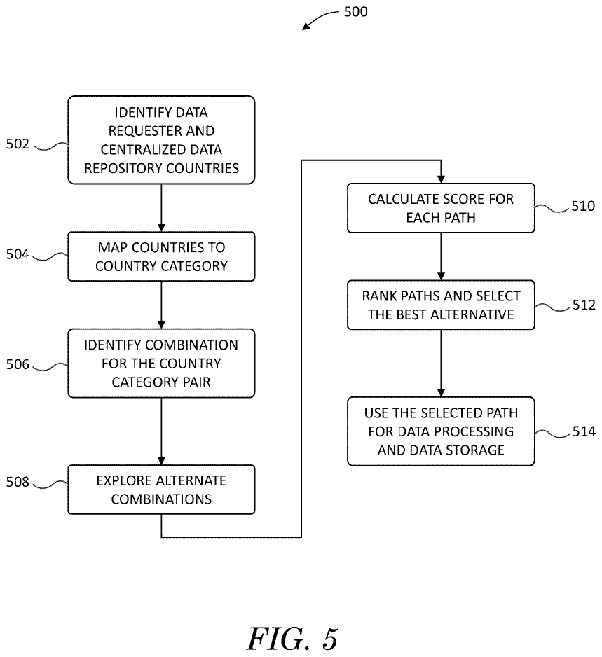

FIG. 5 is a schematic diagram of a process flow 500 performed by the localization engine 48 (shown in FIG. 3) in step 3 of the data sharing process 400 described above, in accordance with an aspect of the present disclosure. In the example embodiment, the localization engine 48 may include an artificial intelligence (AI) model. For example, AI models that may be used for the localization engine 48 include, without limitation, classification models to map countries to regulatory categories like Global or Strict based on localization guidelines. The localization engine 48 may also include optimization and scoring models, such as reinforcement learning or gradient-boosted decision trees, to evaluate multiple criteria (e.g., cost, latency, compliance) to rank data-sharing paths. Additionally, the localization engine 48 may include recommendation models, such as collaborative filtering or neural engines, to explore and suggest optimal combinations of processing and storage paths. The localization engine 48 may also include natural language processing (NLP) models, such as BERT or GPT, to extract regulatory insights unstructured legal documents, rules, and/or texts. The localization engine 48 may also include regression models to predict continuous variables like latency and infrastructure costs using features such as geographic distance or storage technology. Additionally, the localization engine 48 may include sequential decision-making models, such as Markov decision processes or deep Q-networks, to handle dynamic changes in data-sharing policies and infrastructure. Furthermore, the localization engine 48 may include anomaly detection models to identify irregularities in selected paths or operations using methods like clustering or autoencoders. Moreover, in some embodiments, the localization engine 48 may include graph-based models, including knowledge graphs and graph neural networks (GNNs), to process complex relationships between countries, regulations, and storage locations to facilitate optimizing path selection.

As described herein, the localization engine 48 is configured to determine one or more applicable data sharing policies and strategies based on the data requester's geographical location, the regulatory environment, and cultural norms. The localization engine 48 may execute various techniques for analyzing data to identify patterns and solve problems that humans cannot possibly identify or solve. Modeling techniques have been developed that allow parametric or nonparametric statistical analysis of large quantities of data. Such modeling techniques may be used to automatically identify relevant variables (i.e., variables having statistical significance or a sufficient degree of explanatory power) from large data sets. This may include identifying relevant variables or estimating the effect of such variables that indicate actual observations in the data set. This may also include identifying latent variables not directly observed in the data, such as variables inferred from the observed data points.

Use of the AI or machine learning techniques described herein, may begin with training the localization engine 48, or such techniques may begin with a previously trained model, such as the localization engine 48. The localization engine 48 may be trained using supervised or unsupervised training. Additionally or alternatively, the localization engine 48 may be trained by inputting sample data sets or certain data into the model. The AI/ML programs may utilize deep learning algorithms that may be primarily focused on pattern recognition and may be trained after processing multiple examples. The machine learning programs may include Bayesian program learning (BPL), auditory synthesis, optical image or object recognition, and/or natural language processing-either individually or in combination. The machine learning programs may also include natural language processing, semantic analysis, automatic reasoning, and/or machine learning.

In supervised machine learning, the example localization engine 48 may be provided with example inputs and their associated outputs and may seek to discover a general rule that maps the inputs to outputs. Therefore, when subsequent novel inputs are provided to the model, the model may accurately determine a correct output based on the discovered rule. In unsupervised machine learning, the localization engine 48 may be required to find their own structure in unlabeled example inputs.

In one embodiment, the localization engine 48 may be trained by providing the model(s) with a large sample of initial and/or historical training data with known characteristics or features. For example, after the training data has been pre-processed and the feature engineering is complete, the localization engine 48 may be trained using a systematic process that ensures the localization engine 48 can accurately determine applicable data sharing policies and strategies based on a customer's geographical location, the regulatory environment, and available cultural norms.

In an example, the training dataset, which may include labeled examples, may be inputted into the localization engine 48, for example, as feature input vectors. The feature input vectors may include both encoded location data and localization guidelines and mandates data. That is, the location and localization guidelines and mandates data may be converted to numerical values using techniques such as one-hot encoding or embeddings and the like. Numerical features may be normalized or standardized. The localization engine 48 may optimize a loss function suitable for classification, which measures the difference between predicted probabilities and actual labels. The localization engine 48 may use feature importance techniques to weigh inputs, prioritizing features with the highest predictive power. For example, during training and validation, feature importance scores may be generated to provide insights into the attributes most influential in determining a data sharing strategy or policy.

Thus, during training of the localization engine 48, from the training data, one or more feature input vectors representing the countries and localization guidelines/mandates may be passed to the localization engine 48. The localization engine 48 may transform the feature input vectors through multiple layers or decision trees, resulting in one or more latent vectors (e.g., a latent vector for each feature input vector). The latent vectors may be used to compute the localization engine 48 output, which is a prioritization score for a country pairing. The prioritization score may be used to compute a loss value using a loss function. Gradients of the loss function may be calculated with respect to weights and biases in the localization engine 48. Using an optimization algorithm (e.g., gradient descent algorithm, etc.), the localization engine 48 may update the model parameters to minimize the loss, refining the mapping from feature input vectors to output probabilities. The transformations applied during training may refine the latent space. Such a structured approach to training may ensure that the localization engine 48 is robust in determining applicable data sharing policies and strategies based on the customer's geographical location, regulatory environment, and cultural norms.

Referring to FIG. 5, at 502, the localization engine 48 parses the data access request and identifies a geographical location (i.e., a country) of the data requester 12, 14 and a database (such as one of the of the databases 26, 28, and 30 (shown in FIG. 1)) of the CDR 25 (shown in FIG. 1) involved in the data sharing request. The localization engine 48 may use metadata associated with the data access request, such as an IP address, registration details of the data requester 12, 14, location-based API credentials, and the like. The localization engine 48 may ensure that all participating entities are accurately located within their respective jurisdictions to determine relevant regulatory frameworks. If a registration request is also part of the process, the localization engine 48 may record the country associated with the registration for consistent compliance tracking.

At 504, the localization engine 48 maps the geographical locations (i.e., countries) to their predefined country categories-Global, Light, Medium 1, Medium 2, or Strict (discussed above)-based on localization guidelines and regulatory mandates. The country categorization may be defined or derived from a comprehensive database (such as databases 16 and 18 (shown in FIG. 1)) of regulatory policies, privacy laws, and data localization requirements for each jurisdiction. For example, a country classified under “Strict” mandates “local only” processing and storage of all data, whereas a “Global” classification allows unrestricted cross-border data sharing and storage. The mapping ensures that the subsequent processing steps performed by the localization engine 48 are guided by a clear understanding of the regulatory context for each country.

At 506, the localization engine 48 evaluates the country category pair to identify permissible data processing and data storage locations. For example, the localization engine 48 may determine whether the pairing aligns with regulatory requirements, such as ensuring that data originating from a “Strict” country is processed and stored locally. The permissible data processing and storage locations also account for compliance obligations, such as maintaining redundancy in data storage or ensuring that processing centers meet certification standards specific to the originating country.

At 508, the localization engine 48 explores alternate country combinations of data processing and data storage paths. For example, this step may include evaluating different configurations, such as processing data in a nearby “Medium 1” country while maintaining redundant storage in a “Light” country, or distributing tasks across multiple regions to balance regulatory compliance with operational performance. The localization engine 48 may use optimization algorithms to analyze potential paths, considering factors like geographic proximity, infrastructure capabilities, and network latency. Table 2 below illustrates various data processing and data storage combinations.

| Requester | Database | Data | Data |
|---|---|---|---|
| Country | Country | Processing | Storage |
| (A) | (B) | permissible | permissible |
| Global | Global | Global | Global |
| Global | Light | Global or | Light |
| | | Light | |
| Global | Medium 1 | Medium 1 | Medium 1 |
| Global | Medium 2 | Global or | Medium 2 |
| | | Medium 2 | |
| Global | Strict | Strict | Strict |
| Light | Light | Global or | Light A |
| | | Light | or B |
| Light | Medium 1 | Medium 1 | Light or |
| | | | Medium 1 |
| Light | Medium 2 | Global, | * |
| | | Light, | |
| | | Medium 2 | |
| Light | Strict | Strict | * |
| Medium 1 | Medium 1 | * | Medium 1 |
| | | | A or B |
| Medium 1 | Medium 2 | Medium 1 | * |
| Medium 1 | Strict | * | * |
| Medium 2 | Medium 2 | Global or | * |
| | | Medium 1 | |
| | | A or B | |
| Medium 2 | Strict | Strict | * |
| Strict | Strict | * | * |

* = Dependent upon relationship between the countries.

At 510, for each alternate country combination identified, the localization engine 48 calculates a prioritization score. The scoring process includes a detailed assessment of multiple factors, including infrastructure costs (e.g., server and storage expenses, licensing fees) and transaction processing performance (e.g., latency, data transfer speeds). The score is computed using a weighted formula that facilitates minimizing processing and storage infrastructure cost and latency. Each path is assigned a numerical value, with lower scores indicating more favorable options. An example of the prioritization score weighted formula is shown below.

$${S}_{a} = \frac{{P}_{a}^{C} \times {P}_{a}^{L}}{\sum ( {P}_{i}^{C} \times {P}_{i}^{L} )} + \frac{{D}_{a}^{C} \times {D}_{a}^{L}}{\sum ( {D}_{i}^{C} \times {D}_{i}^{L} )}$$

In the above prioritization score weighted formula,

$${P}_{i}^{C}$$

is the processing score's cost component for the i^{th} path,

$${P}_{i}^{L}$$

is the processing score's latency component for the i^{th} path,

$${D}_{i}^{C}$$

is the data storage score's cost component for the i^{th} path, and

$${D}_{i}^{L}$$

is the data storage score's cost latency for the i^{th} path. The a subscript character represents a country pairing path, where each country pairing path is labelled with a different letter, such as a, b, . . . , i. The lower the value of S, the higher the rank of the country pairing path.

The data processing score may be improved by lowering the values of one or more of the data processing score's components,

$${P}_{i}^{C} , {P}_{i}^{L} .$$

Influencing factors of the processing score's components include, for example: i) location of processing region; ii) type of infrastructure (on-prem/cloud); iii) transaction volume processing requirement; and iv) software licensing cost for the given region. Various ways to reduce latency and data processing infrastructure costs include, for example: i) distributed processing; ii) use of CDNs (content delivery networks), iii) automated infrastructure management; iv) containerization and serverless architecture implementation; v) deployment in low-cost regions; and vi) hybrid cloud implementation (on-prem plus cloud).

Similarly, data storage score may be improved by lowering the values of one or more of the data storage score's components,

$${D}_{i}^{C} , {D}_{i}^{L} .$$

Influencing factors of the data storage score's components include, for example: i) data security compliance and regulatory requirements; ii) storage technology (55D/HDD); iii) geographic distribution; and iv) vendor and service provider pricing. Various ways to reduce latency and data storage infrastructure costs include, for example: i) use of cloud data storage; ii) intelligent storage tiering; iii) data caching and constraint (CON) usage; iv) evaluate storage pricing models as provided by vendors; v) data archiving and purging; and vi) data compression and de-duplication.

At 512, after the prioritization scores for all identified paths are calculated, the localization engine 48 ranks the paths in ascending order of their prioritization scores. The localization engine 48 selects the highest-ranked path as the optimal choice for data processing and data storage. The selection process ensures that the chosen path meets all compliance requirements while also optimizing operational efficiency. In an embodiment, the audit/logging module 58 logs the localization engine 48 ranking process for the data access request, allowing audit logs to detail why a particular path was chosen, which enhances accountability and reliability.

At 514, the localization engine 48 implements the selected path for data processing and data storage. For example, in an embodiment, the localization engine 48 may configure the necessary systems, such as initiating data processing in the designated region and ensuring that data is stored in the prescribed location. If the selected path involves multiple regions, the data sharing system 24 may coordinate the necessary workflow(s) to maintain synchronization between the data processing and data storage locations.

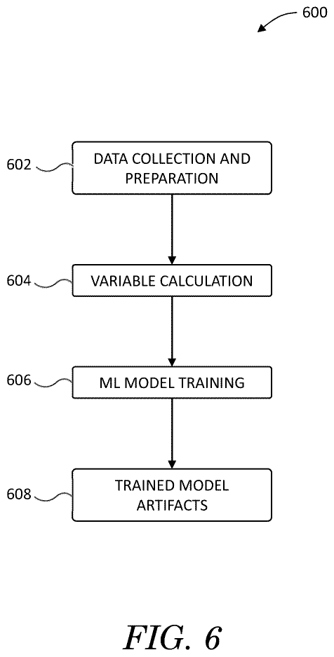

FIG. 6 is a schematic diagram of a process flow 600 for training the machine learning module 50 (shown in FIG. 3), in accordance with an aspect of the present disclosure. In the example embodiment, the machine learning module 50 may include a machine learning (AI) model.

At step 602, the process flow 600 includes collecting and processing training data for training the machine learning module 50. For example, the training process may include collecting historical data related to open banking data access requests. The data may be collected from various sources, such as logs of previous data access requests, system audits, and feedback reports. The collected data may include, for example, records of past requests and their associated metadata, such as the type of institution managing the CDR 25; the country of the data origin and destination; the type of data requested; and whether the requests succeeded or failed. The reasons for failures, typically captured as textual descriptions, may also be included.

The collected raw data may be cleaned to remove duplicates, inconsistent records, and missing values. Missing values in critical fields (e.g., the type of data requested or success/failure results) may be handled using, for example, imputation techniques, such as mean or median imputation for numerical fields or mode imputation for categorical fields. For textual fields like reasons for failure, preprocessing techniques, such as text normalization, tokenization, and stopword removal, may be applied. Statistical methods, such as the Interquartile Range (IQR) or z-score analysis, may be used to identify and remove outliers that could skew model predictions. Similarly, for unstructured textual data (e.g., failure reasons), NLP preprocessing techniques may be applied. These include tokenization, lemmatization, and stopword removal. Advanced techniques like TF-IDF or embeddings (e.g., Word2Vec, BERT embeddings) may be applied to convert text into numerical features.

Step 604 includes calculating and encoding one or more variables used as inputs for the machine learning module 50. The variables include, for example, i) type of institution managing the CDR 25 (T); ii) country category (C); iii) type of data requested (D); iv) previous success/failure results (S); and v) reasons for failure (R). Categorical variables may be converted into machine-readable formats using techniques like one-hot encoding or label encoding. Feature scaling (e.g., normalization or standardization) may be applied to ensure that all numerical inputs are on a comparable scale. After the data is cleaned and preprocessed, the data may be divided into training, validation, and/or test datasets.

The type of institution variable (T) may be a categorical variable representing the type of institution managing the CDR 25 (e.g., Fintech, bank, payment aggregator, or the like). Each type may be encoded using one-hot encoding or label encoding for compatibility with the machine learning module 50. For example, a Fintech may be assigned a higher weight due to its higher likelihood of sharing data.

The country category variable (C) may include a categorical variable indicating the data localization classification of the country involved in the data access request (e.g., Global, Light, Medium 1, Medium 2, or Strict). Each category may be encoded similarly to ensure the machine learning module 50 considers the regulatory stringency in data-sharing decisions.

The type of data requested variable (D) may be a categorical variable specifying the data type (e.g., sensitive authentication data (SAD), cardholder data (CHD), personally identifiable information (PII), protected health information (PHI), or anonymous data). More sensitive data types are weighted to reflect their lower likelihood of being shared. For example, anonymous data might have a higher likelihood of success than personally identifiable information (PII).

The previous success/failure results variable(S) may include a binary target variable that captures whether a data access request was successful (1) or failed (0). The previous success/failure results variable may serve as the classification target variable for the machine learning module 50. This may enable the machine learning module 50 to predict the likelihood of success for future data access requests.

The reason stated by institution in case of failure variable (R) may include a textual failure reason. The text may be transformed into one or more categories using, for example, NLP techniques. Tokenization methods, such as n-grams or term frequency-inverse document frequency (TF-IDF), facilitate extracting features from the text. The features may be clustered into one or more predefined categories (e.g., “regulatory compliance,” “insufficient data permissions.” etc.). The categories may be converted into numerical representations for use in the machine learning module 50.

In the example embodiment, the processed and encoded variables may be normalized and/or standardized to ensure that all input features have consistent scales.

At step 606, the machine learning module 50 may be trained. For example, the prepared data may be fed into to the machine learning module 50. The machine learning module 50 may include a decision tree, random forest, gradient-boosted machine (e.g., XGBoost or LightGBM), or a neural network classifier. The machine learning module 50 may be trained to map the input variables (T, C, D, and R) to the target variable(S). During training, the machine learning module 50 may iteratively learn patterns in the data by minimizing a loss function, such as binary cross-entropy for classification tasks. The machine learning module 50 may be validated on a validation dataset to monitor the model's performance and prevent overfitting. In an embodiment, metrics such as accuracy, precision, recall, and F1-score may be used to evaluate the machine learning module's 50 ability to predict successful data access requests accurately. Hyperparameter tuning may be performed using techniques like grid search or Bayesian optimization to optimize model performance.

At step 608, after the machine learning module 50 is trained and validated, the final model artifacts may be generated and saved. The artifacts may include, for example, the trained model weights, feature importance scores, and encoded variable mappings. The trained machine learning module 50 may be stored in a format compatible with various deployment environments. In addition, documentation detailing the training process, hyperparameters, and performance metrics may also be prepared and stored for future reference. In one embodiment, the trained machine learning module 50 may be integrated into the localization engine 48, where the model processes live data access requests, predicting the likelihood of success based on the localization engine's data sharing policies and strategies, and providing actionable insights based on the input variables.

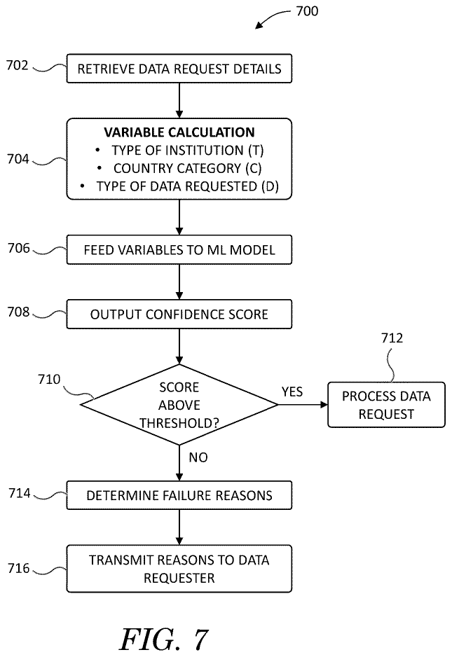

FIG. 7 is a schematic diagram of a model inference process flow 700 for the machine learning module 50 (shown in FIG. 3), in accordance with an aspect of the present disclosure. In the example embodiment, after the localization engine 48 receives a data access request and determines a data sharing policy/strategy, the machine learning module 50 is invoked to determine the likelihood of success of the data access request and provide actionable insights.

At step 702, the machine learning module 50 may retrieve the data access request details from the localization engine 48. The details may include, for example, information about the data requester 12, 14, the type of data being requested, and the geographical locations of both the data requester 12, 14 and the database of the CDR 25 storing the requested data. The data request details form the basis for calculating the variables required as inputs for the machine learning module 50.

At step 704, the machine learning module 50 may calculate the relevant variables for processing. In the example, the relevant variables include the type of institution (T), the country category (C), and the type of data requested (D). The data requester may be categorized based on its type (e.g., Fintech, bank, payment processor, etc.). The data requester categorization may utilize predefined mappings stored by the machine learning module 50. For example, a Fintech institution might have a higher likelihood of data-sharing success compared to traditional banks due to less stringent internal policies. The categorical variable may be encoded using the same one-hot or label encoding scheme applied during model training. The country of the data requester and the CDR 25 may be mapped to predefined localization categories (e.g., Global, Light, Medium 1, Medium 2, Strict). The mappings may be derived from the machine learning module's 50 knowledge base, which may include updated regulatory guidelines. The mapping helps determine whether the request is subject to stringent localization laws that might impact success of the data access request. The specific data being requested (e.g., SAD, CHD, PII, PHI, anonymous data, etc.) may be categorized based on sensitivity. Sensitive data types, such as PII and PHI, may be more likely to face regulatory restrictions compared to anonymous or masked data. The variable may be encoded using the same technique as during training to ensure consistency. The variables may be compiled into a feature vector, normalized or scaled as needed, and validated to ensure the variables match the input requirements of the machine learning module 50.

At step 706, the calculated feature vector may be fed into the pre-trained machine learning module 50. The machine learning module 50 may process the input using the learned weights and parameters. At step 708, the machine learning module 50 may compute a confidence score. The confidence score may represent the likelihood of success for the data access request. In an example, the confidence score may be a numerical value between zero (0) and one (1), where a higher value may indicate greater confidence in a successful data-sharing outcome.

At step 710, the machine learning module 50 may compare the confidence score to a predefined threshold value set during deployment of the machine learning module 50. The threshold value may reflect a tolerance for risk and the importance of maintaining compliance.

If the confidence score meets or exceeds the threshold value, at step 712, the machine learning module 50 may determine that the data access request is likely to succeed. In this scenario, the machine learning module 50 may forward the data access request to the CDR 25 for processing, following the regulatory and operational policies identified earlier by the localization engine 48.

If the confidence score falls below the threshold value, at step 714, the machine learning module 50 may determine that the data access request is likely to fail based on historical patterns. At step 714, the machine learning module 50 may also determine and output one or more probable reasons for the predicted failure. The reasons may be derived from the failure analysis conducted during model training, where textual explanations were categorized using various NLP techniques. For example, as described herein, example reasons may include “regulatory non-compliance due to stringent localization laws,” “insufficient consent permissions,” or “sensitive data type restrictions.”

At step 716, the machine learning module 50 may transmit the probable reasons for failure to the data requester 12, 14, along with the confidence score. The reasons may be presented in a structured format, highlighting key factors contributing to the prediction of the machine learning module 50. The data requester 12, 14 may then be afforded the opportunity to review the potential failure reasons and decide whether to proceed with the data access request.

The data access request may not be automatically forwarded to the CDR 25 if the confidence score is below the threshold value. Instead, the data requester must explicitly decide to have the data access request processed despite the potential reasons for failure. The decision of the data requester 12, 14 may be logged (for transparency and compliance) by the audit/logging module 58. This ensures accountability in instances where the data requester 12, 14 selects to override the prediction of the machine learning module 50. If the data requester 12, 14 selects not to proceed, the data access request may be marked as terminated, and no further action may be taken.

By leveraging both the localization engine 48 and the machine learning module 50, the centralized data repository system 20 provides an adaptive, secure, and efficient framework for data sharing in open banking. The centralized data repository system 20 ensures compliance with diverse regulatory environments while optimizing cost and performance, meeting the demands of financial institutions and their customers worldwide.

The centralized data repository system 20 may incorporate a continuous improvement and adaptation mechanism to ensure long-term effectiveness, compliance with evolving regulations, and alignment with user needs. For example, the localization engine 48 may regularly update its knowledge base to reflect the latest changes in local laws, regulations, and cultural norms related to data privacy and sharing. For example, using advanced NLP techniques, the localization engine 48 may parse unstructured legal documents, policy briefs, and cultural reports available, for example, on public and private databases (such as database 16 and 18 (shown in FIG. 1)) to extract relevant data and integrate it as actionable rules. The updates may be logged for traceability. The updates may ensure the localization engine 48 operates with the most current regulatory framework to minimize the risk of non-compliance.

The machine learning module 50 may continuously update by analyzing real-world data-sharing patterns, customer feedback, and regulatory updates. Feedback and data from successful or failed data access requests may be processed and incorporated into retraining cycles to ensure the machine learning module 50 remains accurate. In some embodiments, incremental learning techniques may allow the machine learning module 50 to adapt to new insights and trends efficiently without requiring full retraining, enabling the machine learning module 50 to adjust to emerging patterns in data processing/storage localization, such as changes in country policies or institution behaviors.

To further improve the performance of the centralized data repository system 20, a structured feedback loop may allow customers and data requesters to provide input and suggestions for refining the data-sharing process. For example, feedback may be collected through system-generated surveys, support channels, and direct user inputs. This mechanism may enable the identification of recurring issues, such as latency concerns or consent verification inefficiencies, and may facilitate prioritizing improvements to optimize user experience and operational workflows.

The centralized data repository system 20 may also ensure ongoing security and resilience through regular audits and penetration testing. For example, one or more automated tools and/or manual testing may be used to evaluate vulnerabilities in the API gateway 46, CDR 25, localization engine 48, and/or machine learning module 50. The assessments may simulate real-world attack scenarios and identify weaknesses, such as potential security gaps in API authentication or encryption protocols. Results from the assessments may be analyzed, and corrective actions may be implemented to maintain the integrity of the centralized data repository system 20 and compliance with global security standards.

### Additional Considerations

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

The detailed description is to be construed as exemplary only and does not describe every embodiment because describing every embodiment would be impractical. Numerous alternative embodiments may be implemented, using either current technology or technology developed after the filing date of this application, which would still fall within the scope of the invention.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

As used herein, the term “database” includes either a body of data, a relational database management system (RDBMS), or both. As used herein, a database includes, for example, and without limitation, a collection of data including hierarchical databases, relational databases, flat file databases, object-relational databases, object-oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor includes a general-purpose processor configured using software, the general-purpose processor may be configured as respective different processors at different times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be in a single location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

What is claimed is:

1. A method comprising:
receiving, via an application programming interface (API) gateway, a data access request from a data requester, the data access request including one or more parameters identifying the data requester, a geographical location of the data requester, requested data, and a type of data requested;
authenticating and authorizing the data access request based on credentials of the data requester and customer consent permissions;
identifying the geographical location of the data requester and a geographical location of a centralized data repository storing the requested data to determine one or more applicable regulatory requirements;
mapping each identified geographical location to a country category based on localization guidelines;
identifying one or more permissible country combinations for data processing and data storage locations based on the country categories, each combination defining a data-sharing path;
analyzing one or more alternative data-sharing paths;
determining a prioritization score for each data-sharing path and alternative data-sharing path using a scoring mechanism that incorporates infrastructure cost, data processing latency, and regulatory compliance factors;
selecting a data-sharing path having the lowest prioritization score;
retrieving the requested data from the centralized data repository; and
securely transmitting the requested data to the data requester through the API gateway along the selected data-sharing path.

2. The method in accordance with claim 1,
the step of mapping each identified geographical location to a country category comprising using a knowledge base of local laws, regulations, and cultural norms.

3. The method in accordance with claim 1,
the step of analyzing one or more alternative data-sharing paths includes analyzing combinations of data processing and data storage locations to optimize compliance with regulatory requirements and minimize data transfer latency.

4. The method in accordance with claim 1,
the step of determining the prioritization score comprises evaluating, for each data-sharing path:
data processing infrastructure cost;
data processing latency;
data storage infrastructure cost; and
data storage latency.

5. The method in accordance with claim 1, further comprising:
training a machine learning module, wherein the machine learning module is trained by analyzing variables comprising:
a type of institution managing the centralized data repository;
a country category;
the type of data requested;
previous success or failure results for data access requests; and
one or more reasons stated for prior data access request failures.

6. The method in accordance with claim 5, further comprising:
feeding historical data-sharing patterns, customer preferences, and prior outcomes into the machine learning module to optimize the selection of the data-sharing path.

7. The method in accordance with claim 5, further comprising:
generating, via the machine learning module, a confidence score for a predicted success of the data access request.

8. The method in accordance with claim 7, further comprising:
comparing the confidence score to a predefined threshold value;
determining that the confidence score meets or exceeds the predefined threshold value; and
transmitting the data access request to the centralized data repository.

9. The method in accordance with claim 7,
comparing the confidence score to a predefined threshold value;
determining that the confidence score is below the predefined threshold value; and
transmitting one or more probable reasons for failure and the confidence score to the data requester.

10. The method in accordance with claim 9, wherein the one or more probable reasons for failure are generated using natural language processing techniques applied to historical failure logs and categorized into actionable insights.

11. The method in accordance with claim 5, further comprising:
incorporating feedback from customers and data requesters into the machine learning module to refine and optimize the selection of the data-sharing path.

12. The method in accordance with claim 5, further comprising:
retraining the machine learning module using newly collected historical data, updated regulatory rules, and feedback.

13. The method in accordance with claim 1, further comprising:
conducting one or more security audits and penetration testing on one or more of the following: the API gateway and the centralized data repository.

14. The method in accordance with claim 1, further comprising:
transforming the requested data, wherein the operation of transforming includes one or more of the following: anonymizing, masking, and aggregating,
the type of requested data including one or more of the following: sensitive authentication data (SAD), cardholder data (CHD), personally identifiable information (PII), and protected health information (PHI).

15. The method in accordance with claim 1, further comprising:
encrypting the requested data using end-to-end encryption protocols to ensure the confidentiality and security of the requested data in transit.

16. A system comprising:
a centralized data repository storing customer financial data thereon; and
a data sharing system comprising:
an application programming interface (API) gateway;
a localization engine;
a machine learning module;
one or more processors; and
a memory storing executable instructions that, when executed by the one or more processors, cause the one or more processors to:
receive, via the API gateway, a data access request from a data requester, the data access request including one or more parameters identifying the data requester, a geographical location of the data requester, the customer financial data being requested, and a type of data requested;
authenticate and authorize, via the API gateway, the data access request based on credentials of the data requester and customer consent permissions;
identify, via the localization engine, the geographical location of the data requester and a geographical location of a centralized data repository storing the requested data to determine one or more applicable regulatory requirements;
map, via the localization engine, each identified geographical location to a country category based on localization guidelines;
identify, via the localization engine, one or more permissible country combinations for data processing and data storage locations based on the country categories, each combination defining a data-sharing path;
analyze, via the localization engine, one or more alternative data-sharing paths;
determine, via the localization engine, a prioritization score for each data-sharing path and alternative data-sharing path using a scoring mechanism that incorporates infrastructure cost, data processing latency, and regulatory compliance factors;
select, via the localization engine, a data-sharing path having the lowest prioritization score;
retrieve the requested data from the centralized data repository; and
securely transmit, via the API gateway, the requested data to the data requester along the selected data-sharing path.

17. The system in accordance with claim 16,
the step of mapping each identified geographical location to a country category comprising using a knowledge base of local laws, regulations, and cultural norms.

18. The system in accordance with claim 16,
as part of the step of analyzing one or more alternative data-sharing paths, the executable instructions cause the one or more processers to:
analyze combinations of data processing and data storage locations to optimize compliance with regulatory requirements and minimize data transfer latency.

19. The system in accordance with claim 16,
as part of the step of determining the prioritization score, the executable instructions cause the one or more processers to evaluate, for each data-sharing path:
data processing infrastructure cost;
data processing latency;
data storage infrastructure cost; and
data storage latency.

20. The system in accordance with claim 16, the executable instructions further cause the one or more processers to:
train the machine learning module, wherein the step of training includes analyzing variables comprising:
a type of institution managing the centralized data repository;
a country category;
the type of data requested;
previous success or failure results for data access requests; and
one or more reasons stated for prior data access request failures.
